(19) United States
(12) Patent Application Publication
(10) Pub. No.: US 2025/0390679 A1
(43) Pub. Date: Dec. 25, 2025

(54) SYSTEM FOR LEGAL PRECEDENT PREDICTION & RELATED TECHNIQUES

(71) Applicant: Massachusetts Institute of Technology, Cambridge, MA (US)

(72) Inventors: Robert Zev Mahari, Zug (CH); Alex Paul Pentland, Cambridge, MA (US)

(73) Assignee: Massachusetts Institute of Technology, Cambridge, MA (US)

(21) Appl. No.: 19/065,400

(22) Filed: Feb. 27, 2025

Related U.S. Application Data
(63) Continuation of application No. 17/809,449, filed on Jun. 28, 2022, now abandoned.

(51) Int. Cl. G06F 40/295; G06F 40/30; G06Q 50/18

(52) U.S. Cl. CPC G06F 40/295; G06F 40/30; G06Q 50/18

(57) ABSTRACT

Described is a system and technique for identifying passages of legal precedent and assembling arguments that use this precedent. In embodiments, passages of judicial precedent are identified by taking advantage of a network of judicial citations. In embodiments, identified passages and relevant context from legal opinions are assembled into a synthetic argument that can be used to identify and/or predict relevant legal precedent. In embodiments, the system and technique may be used identify and/or predict precedent relevant to new arguments. The described the system and technique uses state-of-the-art natural language processing techniques, in particular transformer-based language models trained on a legal corpus, to identify and/or predict precedent relevant to a legal argument.

### CROSS REFERENCE TO RELATED APPLICATION

This application is a continuation of and claims priority to U.S. application Ser. No. 17/809,449, which was filed on Jun. 28, 2022. The entire contents of that application are incorporated herein by reference.

### STATEMENT REGARDING FEDERALLY SPONSORED RESEARCH

N/A

### BACKGROUND

As is known in the art, in common law jurisdictions, like the United States, judges and lawyers construct legal arguments by drawing on holdings from past court decisions (or “opinions”). Such holdings are sometimes referred to as “case law,” “judicial precedent,” “legal precedent” or more simply “precedent.”

Table 1 presents an anatomy of a typical legal argument. In Diamond v. Chakrabarty, 447 U.S. 303 (1980) the U.S. Supreme Court cites two passages of precedent (underlined text). The first expresses a legal standard concerning statutory interpretation, the second provides a definition of “manufacture.” In this example, the Court applies the standard to conclude that the creation of new micro-organisms constitutes “manufacture” and is therefore patentable.

TABLE 1

| | |
|---|---|
| Case Background | [Is] a live, human-made micro-organism patentable subject |
| | matter[?] |
| Legal Question | We must determine whether respondent's microorganism |
| | constitutes a “manufacture” or “composition of matter” within the |
| | meaning of the statute. |
| Legal Standard | “unless otherwise defined, words will be interpreted as |
| | taking their ordinary, contemporary, common meaning.” |
| | Perrin v. United States, 444 U.S. 37, 42 (1979). |
| Standard | This Court [defines] “manufacture” as “the production of |
| Application | articles for use from raw or prepared materials by giving to these |
| | materials new forms, qualities, properties, or combinations, |
| | whether by hand-labor or by machinery.” American Fruit |
| | Growers, Inc. v. Brogdex Co., 283 U.S. 1, 11 (1931) . . . The patentee |
| | has produced a new bacterium with markedly different characteristics |
| | from any found in nature . . . |
| Conclusion | [The patentee's] discovery is not nature's handiwork, but |
| | his own; accordingly it is patentable subject matter |

Judges, arbitrators, mediators and other persons deciding disputes (or “cases”) between parties cite precedent in their reasoning and apply it to the facts of a case to build incrementally towards a final judgement (also referred to as a “decision” or an “opinion”). Lawyers use precedent in legal briefs presented to courts to argue why one party to the dispute should prevail. Legal briefs are structured similarly to judicial opinions but advocate for a certain legal conclusion (e.g., the defendant's actions cannot be considered a “crime” under current law). Both judicial opinions and legal briefs usually contain a number of independent legal arguments—each citing its own set of precedent. The precedent contained in these arguments depends upon the context of the entire case as well as on the specific legal argument being made.

U.S. case law currently includes around 6.7 million published judicial opinions, written over approximately 350 years. The process of extracting the correct precedent from this daunting corpus is a fundamental part of legal practice. It is estimated that law firm associates spend one-third of their working hours conducting legal research. Lawyers rely on legal research platforms to access and search legal precedent, which charge $60 to $99 per search, a cost that is ordinarily passed on to clients.

Access to justice continues to be a serious problem in the United States, and “86% of the civil legal problems reported by low-income Americans received inadequate or no legal help. Similarly, in criminal cases, U.S. public defenders, who provide legal services to individuals who have been charged with a crime and face imprisonment but cannot afford a lawyer, frequently handle hundreds of cases simultaneously and are thus unable to devote the necessary time to each individual's case. As attorney fees continue to rise and approach $300 per hour on national average the price of legal advice is becoming increasingly unaffordable and access to justice is diminishing accordingly.

Identifying precedent is a task fundamental to the practice of law. Given the time, expertise, and costs associated with identifying relevant precedent, this task represents a major barrier for widespread access to justice.

As is also known, in recent years, the law has increasingly attracted attention from the natural language processing (NLP) community. Several of the recently proposed legal NLP methods solve technical NLP challenges unique to the law, but fail to address the needs of the legal community. For example, one technique which relies on artificial intelligence is referred to as Legal Judgement Prediction (LJP). The LJP approach seeks to predict a legal judgement (ordinarily made by judges) on the basis of relevant facts and laws. In practice however, judges are unlikely to defer to artificial intelligence to decide the fate of a court case.

Other prior art approaches to predicting legal citations utilize models trained on U.S. Supreme Court opinions while ignoring opinions from other courts and administrative bodies (e.g., the U.S. Patent Trial and Appeal Board).

### SUMMARY

Described are concepts, systems and techniques to identify passages or portions of documents relevant to a legal argument. In short, in one aspect described are a system and technique to identify one or more passages from or one or more portions of one or more legal documents having probability (and ideally a high probability) of being relevant from a fixed (or given) set of passages. In another aspect described are a system and technique to predict the probability that a given passage will be relevant to a given argument. The documents may include, but are not limited to court decisions, judicial commentary or other legal writings and the identified portions of the documents may be, but is not limited to, text from one or more of the documents, citations of the documents (e.g., citations of court decisions) and the like. The text may relate to legal precedent relevant to a legal argument of interest.

In contrast to prior art techniques, the system and techniques described herein evaluate models by predicting numerous citations (not limited to U.S. Supreme Court opinions) relevant to a given opinion and checking how many of these citations are actually contained in a given opinion. The system and technique do the checking about whether a citation is contained as part of constructing training data. For example, if opinion A contains a quote and a reference to opinion B, then opinion B is checked to ensure it actually contains the quote.

To this end, the concepts, systems and techniques described herein utilize one or more databases or storage devices (e.g., a network of storage devices) having collectively stored therein a corpus of judicial opinions and/or digitized versions of other documents (e.g. documents which comment upon or otherwise refer to judicial opinions) and a processor configured to identify portions of (e.g., passages in) judicial opinions (e.g., passages containing statements of legal precedence) within the corpus of judicial opinions and configured to assemble legal arguments from the identified passages. The systems and techniques subsequently use the assembled arguments in which precedential passages appear to identify those passages of precedent which should be cited to make a given legal argument. In one embodiment, in the context of U.S. federal law, systems and techniques operating in accordance with the concepts described herein identifies a correct precedential passage with a top ten (10) accuracy of 96%. In embodiments, the model may be tested in two ways. First, the model may be tested using held-out training data (i.e., synthetic arguments that the model has not seen before). In embodiments, the top-10 accuracy means the correct target passage is among the top-10 predictions 96% of the time.

In embodiments, the model is tested on two legal briefs which have been manually summarize (and it is noted that manual summary of complex legal documents is work/time intensive task). In the briefs, about 70% (7/10) of the predictions were found to be relevant (which is a different measure of performance than the measure of performance described above).

The concepts, systems and techniques described herein are unique in that they significantly depart from largely manual approaches currently used in legal practice.

Furthermore, by using advanced natural language processing (NLP) and transformer-based modeling, the concepts, systems and techniques described herein significantly outperform prior art systems and techniques that rely on different technical approaches.

More importantly perhaps, the described concepts, systems and techniques offer significant time and cost savings compared to traditional legal research methods which rely on manual searching of precedent by trained attorneys. Finally, the described concepts, systems and techniques are agnostic to jurisdictions and can readily be deployed in any common law context including U.S. federal law, U.S. state law, and any foreign jurisdictions (e.g., Australia, Canada, Europe (EP) and United Kingdom (U.K.)).

In one aspect, described is a technique for identifying passages of text corresponding to or related to legal precedent. In embodiments, passages of legal precedent are identified by accessing one or more databases (e.g., a network of databases) having judicial decisions and/or other documents related to legal decisions stored therein and using NLP to search the documents for passages of text related to legal precedent.

In a further aspect of the concepts described herein, also described is a technique for assembling identified passages of precedent. An argument identification processor assembles the context from the opinions citing each passage into a “synthetic” argument that can be used to predict precedent relevant to a legal argument. In embodiments, the legal argument may be a new (or novel) argument.

In a still further aspect of the concepts described herein, also described is a technique for using assembling identified passages of precedent to predict precedent relevant to a legal argument. In embodiments, a prediction processor uses assembled identified passages of precedent to predict precedent relevant to a legal argument

The concepts described herein utilize natural language processing techniques, and in particular utilize transformer-based language models trained on a legal corpus, to predict precedent relevant to a new legal argument. In embodiments, other NLP techniques may, of course also be used. For example, in embodiments, a Feed Forward Neural Network: Our approach to assembling training data and predicting precedent can work with any number of NLP approaches.

### DESCRIPTION OF THE SEVERAL VIEWS OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principals of the concepts described herein. Like reference numerals designate corresponding parts throughout the different views. Furthermore, embodiments are illustrated by way of example and not limitation in the figures, in which:

FIG. 1 is a block diagram of a system for predicting legal precedent;

FIG. 2A is a block diagram of neural network flow for a system for predicting legal precedent using a LEGAL-BERT model;

FIG. 2B is a block diagram a system for predicting legal precedent illustrating of neural network flow for a feed forward neural network (FFNN);

FIG. 3 is a plot of complementary cumulative distribution vs. citation counts;

FIGS. 4A and 4B are a flow diagram of a process for predicting legal precedent; and

FIGS. 5A and 5B are diagrammatic representations of identifying missing precedent in a synthetic legal argument and providing missing precedent for the synthetic legal argument.

### DETAILED DESCRIPTION

Before describing the details of a system for identifying (or predicting) passages (e.g., text) of judicial precedent that are relevant to a given legal argument made in the context of a judicial opinion or a legal brief, some introductory concepts and terminology are described. In this context, the phrase “judicial precedent” refers to a rendered written court decision (i.e., a case decided by a court, an administrative board or other legal authority) and having a legal holding which may be influential in deciding other cases. In general overview, described is a system and technique (sometimes referred to herein as Legal Precedent Prediction or LPP) which utilizes natural language processing (NLP) to address an unmet need of the legal community. LPP is defined herein as the task of identifying/predicting passages of judicial precedent relevant to a given legal argument made in the context of a judicial opinion or a legal brief, and which might provide an appropriate citation for a given proposition in the opinion or brief. Thus, LPP models described herein seek to identify one or more specific passages from prior legal opinions relevant to a specific legal argument

The described NLP approach to identifying judicial precedent relevant to a given legal argument utilizes one or more models trained on legal arguments which appear in judicial opinions. Such judicial opinions may include, but are not limited to, those authored by U.S Supreme Court Justices, U.S. federal judges and/or State judges. The purpose of such a model is to aid attorneys, paralegals, legal practitioners and others (collectively, “legal counsel”) in drafting legal briefs, thereby reducing the amount of time (and in at least some case, the amount of money) spent on legal research. Thus, the concepts, systems and techniques described herein have the potential to augment attorneys' ability to identify relevant precedent in a cost- and time-effective manner.

By reducing the amount of time required to perform legal research, legal counsel can provide a higher quality of legal services to clients and can also service more clients thereby increasing access to justice. It should also be appreciated that the system and techniques described herein (sometimes referred to herein simply as a “tool”) could identify precedent that counsel would not have found, so not only offering time/cost saving but also improving the quality of legal service directly. This is particularly true for underfunded or unfunded legal counsel such as pro bono attorneys and/or public defenders. Accordingly, the concepts, systems and techniques described herein may increase access to justice (i.e., LPP has the potential to promote access to justice by augmenting attorneys' ability to identify precedent in a cost- and/or time-efficient manner and thereby reduce the cost of litigation).

For example, and with reference to Table 1 (repeated here, for convenience), in accordance with the concepts described herein, given the Case Background, Legal Question, Standard Application, and Conclusion an LPP model should identify the passage in the Legal Standard row of Table 1 below from Perrin v. United States, 444 U. S. 37, 42 (1979) (hereinafter Perrin).

TABLE 1

| | |
|---|---|
| Case Background | [Is] a live, human-made micro-organism patentable subject |
| | matter[?] |
| Legal Question | We must determine whether respondent's microorganism |
| | constitutes a “manufacture” or “composition of matter” within the |
| | meaning of the statute. |
| Legal Standard | “unless otherwise defined, words will be interpreted as |
| | taking their ordinary, contemporary, common meaning.” |
| | Perrin v. United States, 444 U.S. 37, 42 (1979). |
| Standard | This Court [defines] “manufacture” as “the production of |
| Application | articles for use from raw or prepared materials by giving to these |
| | materials new forms, qualities, properties, or combinations, |
| | whether by hand-labor or by machinery.” American Fruit |
| | Growers, Inc. v. Brogdex Co., 283 U.S. 1, 11 (1931) . . . The patentee |
| | has produced a new bacterium with markedly different characteristics |
| | from any found in nature . . . |
| Conclusion | [The patentee's] discovery is not nature's handiwork, but |
| | his own; accordingly it is patentable subject matter |

In embodiments, the system and technique described herein utilizes an LPP model trained on judicial arguments in opinions from all courts in a jurisdiction relevant to the dispute being decided. Such opinions may be stored in one or more databases. In embodiments, judicial arguments in opinions from all courts in the U.S. Federal court system are used to train an LPP model. In embodiments, judicial arguments in opinions from all U.S. State Courts may be used to an LPP model. In embodiments, judicial arguments in opinions from all U.S. State and U.S. Federal courts may be used to train an LPP model. In embodiments, judicial arguments in opinions from all U.S. State and U.S. Federal courts as well as on arguments in opinions from other legal authorities may be used to train an LPP model. By training the LPP model on individual judicial arguments, the model can learn domain specific connections. Such domain specific connections may be missed by systems and techniques which utilize only a topic model.

When a system provided in accordance with the concepts and techniques described herein is tested on judicial opinions and legal briefs, the described the system and technique achieves a precision of 72%. It should be appreciated that, as used herein, the term “precision” refers to a fraction of relevant instances among retrieved instances. For example, a model may be given one hundred (100) arguments associated with one hundred (100) different target passages from judicial opinions and one would expect the system described herein to predict the correct passage seventy-two (72) times. Furthermore, it should be appreciated that rather that predicting just one passage, it is also possible to also ask the model to predict ten (10) passages and top-10 accuracy measures how often the correct passage is among the top ten (10) passages.

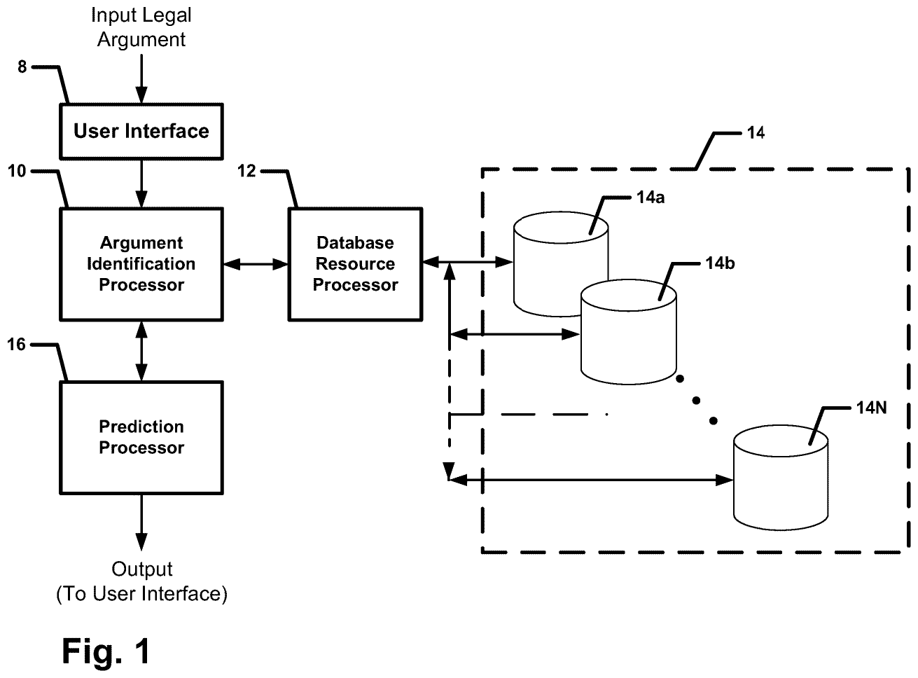

Referring now to FIG. 1, a system for predicting legal precedence includes a user interface (U/I) 8 configured to allow a user to input a legal argument to an argument identification processor 10. It should be appreciated the input of a legal argument, rather than a legal term, is a significant departure from how legal research is currently done using conventional systems and techniques. Thus, rather than searching for a legal term such as “attractive nuisance” counsel can simply input “Defendant is liable for injuries to the young plaintiff because defendant failed to place a fence around his pool” and the model would identify citations about attractive nuisance supporting this position.

Argument identification processor 10 is coupled through a database resource processor 12 to one or more database 14a-14N, generally denoted 14 having judicial arguments stored therein. In embodiments, database 14 may have stored therein one or more of: judicial arguments in opinions from the U.S. Supreme Court; judicial arguments in opinions from the U.S. Federal court system, judicial arguments in opinions from U.S. State Courts, and/or judicial arguments in opinions from other legal authorities. In embodiments, each database 14a-14N may have a particular type of legal resource stored therein. For example, in embodiments, database 14a may have stored therein judicial arguments contained in opinions from the U.S. Supreme Court; database 14b may have stored therein judicial arguments in opinions from all U.S. Federal courts; and database 14N system may have stored therein judicial arguments in opinions from all U.S. State Courts.

A user provides a legal argument to argument identification processor 10 through U/I 8. In response to the information provided thereto, argument identification processor 10 accesses database 14 via database resource processor 12. Among other things, database resource processor 12 determines which portions of database 14 to access. For example, if the legal argument presented is strictly a matter of U.S. Federal law, database resource processor 12 identifies those portions of database 14 related to U.S. Federal law. Similarly, if the legal argument presented is strictly a matter of U.S. State law, database resource processor 12 identifies those portions of database 14 related to U.S. State law. Further still, if the legal argument presented is strictly a matter of law of a specific U.S. State, database resource processor 12 identifies those portions of database 14 corresponding to the law of the specific U.S. State. In this way, database resource processor 12 filters (so to speak) information in database 14 such that argument identification processor 10 need not process all information in database 14. Thus, database resource processor 12 functions, at least in part, such that argument identification processor 10 need only process that information in database 14 which may be relevant to a legal question presented to argument identification processor 10. This approach makes efficient use of processing resources as well as efficient use of user time.

Once appropriate legal resources in database 14 are identified, argument identification processor 10, searches the database to identify one or more judicial opinions (e.g., A opinions) and processes each opinion to identify citations to other opinions and to identify relevant quotations in any of the identified opinions. Argument identification processor 10 also checks if any of the relevant quotations are followed by a citation to one or more other opinions (e.g., B opinions) and further determines if the quoted text is contained in the one or more cited opinions (i.e., one or more of the B opinions). If the argument identification processor 10 determines the quoted passage appears in one or more of the cited opinions (i.e., one or more of the B opinions), then argument identification processor 10 extracts text before and after quotation in opinion A and text from introduction and conclusion of opinion A.

As explained herein, one should distinguish between model training and model execution for the user. For training it is necessary to create so-called synthetic arguments. In embodiments, experiments were conducted using different amounts of text before and after a passage and settled on a quantity of text which produced desired results. In embodiments, a quantity of text is measured in number of characters, so it may include incomplete sentences. These synthetic arguments may be used to train a model to identify precedent based upon an argument. However, once a model is trained, it is not necessary to any longer utilize synthetic arguments.

In embodiments, argument identification processor 10 may be provided as a feed forward neural network (FFNN) a.k.a. a multi-layered perceptron (MLP). Other types of processing elements may, of course, also be used.

In one embodiment, at least a portion of database 14 may correspond to a database from the Case Law Access Project (CAP) which provides researchers with access to 6.7 million published judicial opinions. In these opinions, judges cite prior legal decisions (i.e., “legal precedent”) by quoting directly, summarizing, or simply referencing precedent (e.g., Perrin v. United States, 444 U. S. 37, 42 (1979)) in support of an argument. A single opinion is likely to contain many arguments, each resting on a different set of citations.

In one embodiment, a system provided in accordance with the concepts described herein utilized 1.7 million federal judicial opinions contained in CAP (i.e., the system utilized portions of one or more databases containing legal opinions. These 1.7 million federal judicial opinions included all opinions handed down from the U.S. Supreme Court, 13 federal appellate courts and 94 federal district courts. These 1.7 million opinions contain 13.8 million citations of precedent, 7.4 million of which are accompanied by a quoted passage from a prior case. Regular expressions (i.e., a computer technique to identify one or more patterns in text) were used to extract these citation-passage pairs and match them to the cited opinion text (to exclude any inaccurate citations). For example, the expression “fish[a-z]{2,3}” matches fish followed by 2-3 lowercase letters, so it would match fishing, fisher, fished but not fish or fish123. In embodiments, regular expressions that identified legal citations (e.g., such as “304 U.S. 64”) may be used. Ultimately, in one example embodiment, 1.5 million unique cited passages were identified.

It has been recognized that judicial citations obey a power law distribution. In one embodiment, the 5,000 most frequently cited passages were selected to train an LPP model. Although these passages represent less than 0.5% of all cited passages, they account for approximately 19% of all passage citations and, as will be shown, appear frequently in legal briefs. These frequently cited passages appear a total of 560,000 times.

As shown in the example in Table 1 above, legal counsel (e.g., judges and lawyers and others) often express a legal argument and then refer to one or more passages in a prior legal document in support of the argument. The reference is often in the form of a quote and is often referred to as legal precedent.

In one example embodiment, data collected from CAP was used to train two models to predict a correct target passage given local context surrounding this passage in the opinion citing it, as well as the global context from the introduction and conclusion of the opinion, which often contain general background relevant to the case.

This task was treated as a multi-class classification problem and two different models were trained.

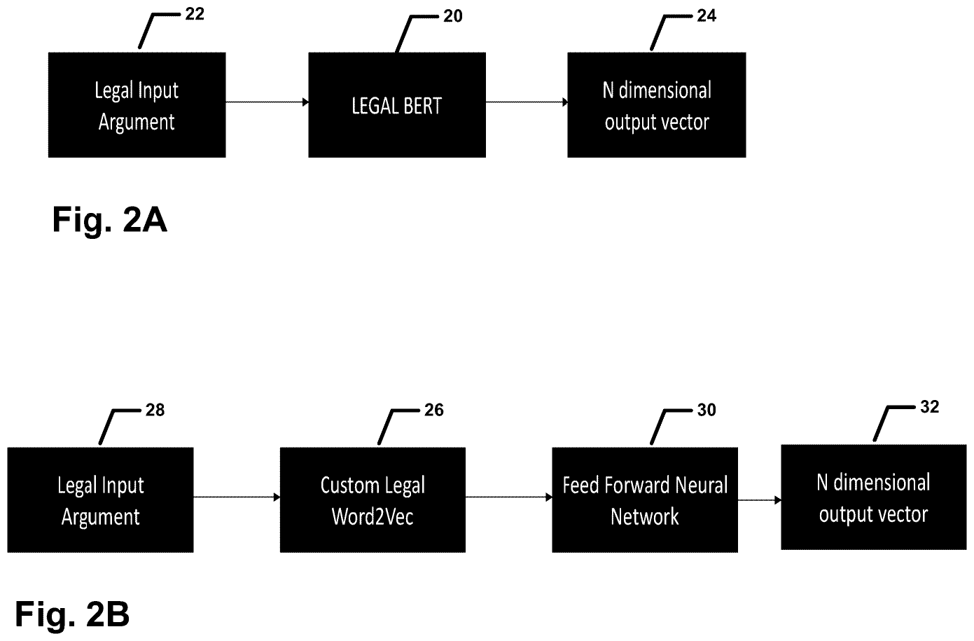

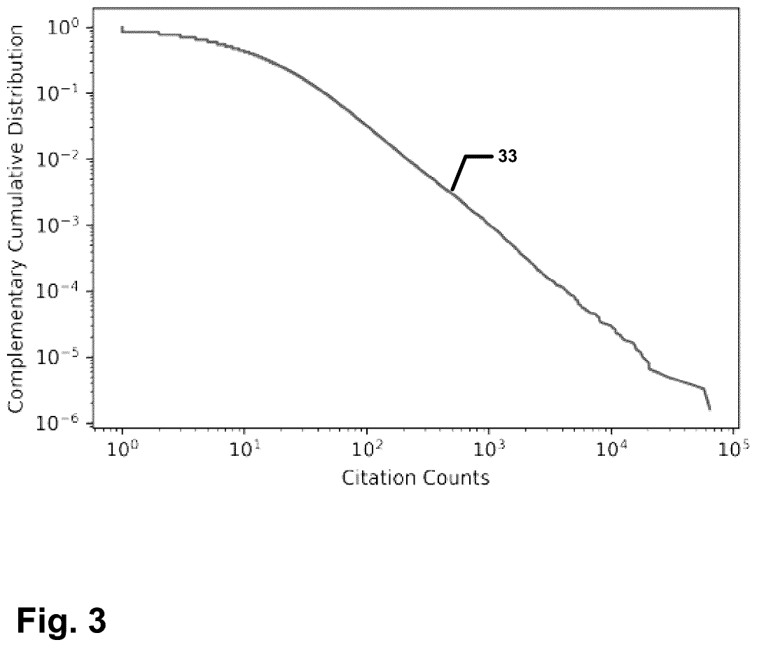

Referring to FIG. 2A in a first example embodiment, a first machine learning (ML) model corresponding to a pretrained bidirectional encoder representations from transformers (BERT) model was used. In particular, a family of BERT models 20 for the legal domain (referred to as “LEGAL-BERT”) was used and fine-tuned to predict passages. Essentially the LEGAL-BERT model creates a mathematical representation of a legal text, but it does not do so with a specific purpose in mind. By fine-tuning this general-purpose model may be trained on the specific task at hand, e.g. to predict passages of precedent based on a input argument.

Because BERT does not treat words separately, but instead also models interactions between words, BERT has an input length which is limited compared with other models (i.e., a limited input window), and thus a smaller context window of 300 characters to either side of the target passages as well as 300 characters from the introduction and conclusion were extracted. Thus, the model can only handle so many words in an input sequence and for convenience a fixed number of characters to make ensure inputs do not exceed a maximum allowable length.

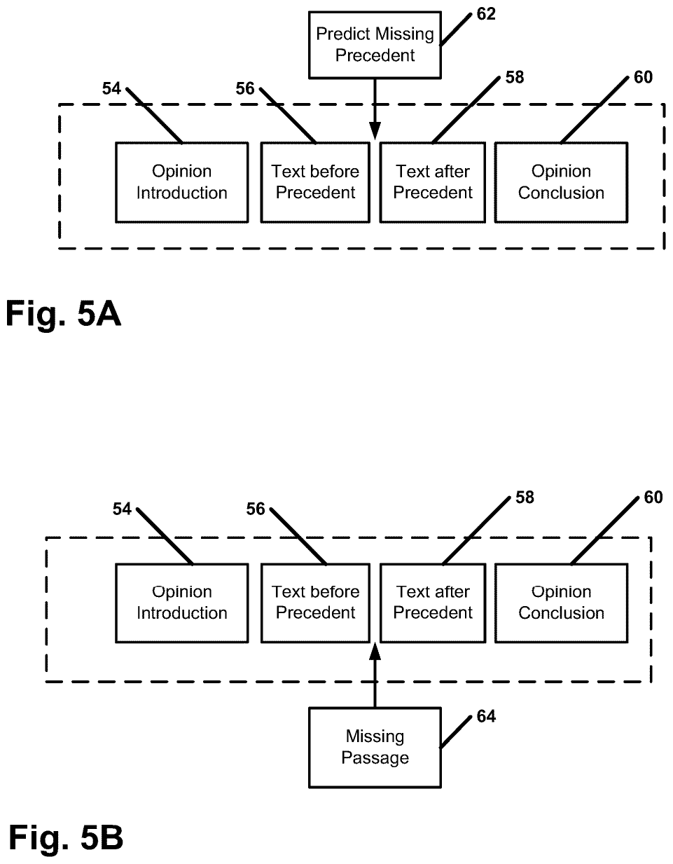

In embodiments, LEGAL-BERT is pretrained on legal language and so no further domain specific modifications need be made. The four context windows (i.e., elements 54, 56, 58, 60 in FIGS. 5A 5B) were concatenated together in the order they appeared in the original opinion to form “mini-opinions”. It should be appreciated that the goal is that these chunks of text contain sufficient detail about the legal argument being made the enable the model to learn how to identify a relevant passage of precedent.

In response to a legal input argument 22 provided thereto, the trained LEGAL-BERT model 20 processes the legal argument 22 and provides an N-dimensional output vector 24 representing passages of judicial opinions of interest.

Only minimal preprocessing of the input argument 22 was performed. For example, all characters other than letters were discarded and all letters were set to lowercase. The name of and reference to the opinion containing the target passage was removed, if it appeared in the context.

Referring to FIG. 2B, in the second model, a three-layer feed forward neural network (FFNN) using custom continuous bag of word (CBOW) word vectors to represent contexts was trained on the same task.

For the FFNN, a local context window of a selected number of characters to either side of the target passage was extracted to represent the specific legal argument being made. Unlike BERT, the FFNN is not limited by input length. However, in embodiments, a limited amount of text is used to ensure only text about a specific legal argument is captured. If too much text is used, there exists a risk of having multiple arguments in the input. In embodiments, the selected number of characters is in the range of 100-1000 characters. In embodiments, the selected number of characters is in the range of 200-600 characters. In embodiments, the selected number of characters is in the range of 300-500 characters. In embodiments, 400 characters to either side of the target passage may be used (i.e., 400 characters to either side of the target passage are extracted to represent the specific legal argument being made). The particular number of characters to use in any particular application may be empirically selected.

Additionally, a first and last number of characters in each training opinion may be extracted to capture the general opinion context. Since introductions and conclusions tend to be longer pieces of text, it may be desirable to use more text here than are used to identify a specific legal argument being made. In embodiments, the first and last 2,500 characters in each training opinion may be extracted to capture the general opinion context. The particular number of characters to use in any particular application may be empirically selected.

In embodiments, to ensure that the word embeddings would successfully capture “legalese” domain specific meanings of words, a custom 300-dimensional CBOW Word2Vec embedding was trained on all federal judicial opinions (approximately 6 billion tokens). All tokens that appeared at least 1,000 times were included in the vocabulary.

As in the above example, only minimal preprocessing was performed. For example, all characters other than letters were discarded and all letters were set to lowercase. The name of and reference to the opinion containing the target passage was removed, if it appeared in the context. Finally, for the FFNN only, stop words were removed.

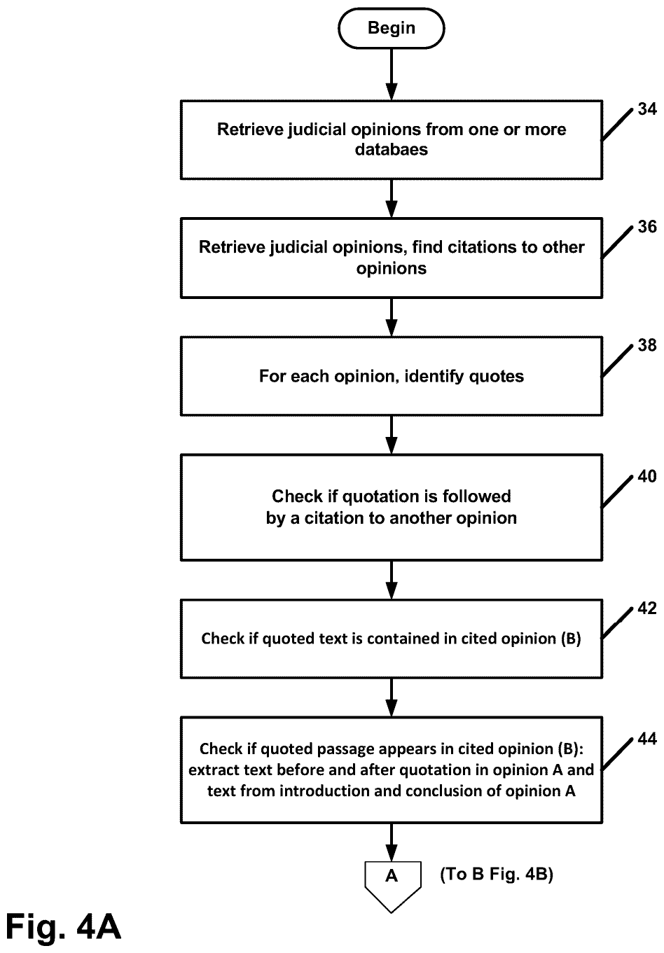

As mentioned above and as illustrated by curve 33 in FIG. 3, citation frequency obeys a power law distribution, with a small number of citations being cited very frequently. This distribution results in an imbalanced dataset which must be addressed to avoid training a model that only predicts the most frequent citations. Moreover, the distribution makes simple under-sampling techniques infeasible: the least cited passage in the training data was cited twenty-six (26) times, therefore under-sampling would require discarding almost 80% of the training data. To overcome these challenges in the FFNN, the minority classes in the training data were synthetically over-sampled, using a synthetic minority over-sampling technique (SMOTE). In essence, SMOTE generates new minority class training examples by interpolating between existing minority class data points.

The BERT model was trained on the original imbalanced training data.

### BERT Model

“Mini-opinions” (also sometimes referred to herein as “synthetic arguments”) (see FIGS. 5A, 5B below) are formed and each mini-opinion was tokenized using the LEGAL-BERT tokenizer and padded to a length of 340 tokens (the length of the longest “mini opinion” was 336 tokens). The pretrained LEGAL-BERT model was fine-tuned using known techniques with the exception of the batch size which was reduced to 8 (instead of the recommended 16 or 32) to enable fine-tuning on a single Geforce RTX™ 2080 GPU with 8 GB of memory. The BERT model was trained to output a 5,000-dimensional vector corresponding to the 5,000 possible passages. The training data was shuffled and 5% (28,000 examples) was reserved for testing.

### FFNN Model

The input 28 to the FFNN model 30 was the concatenation of four vectors representing the global context at the beginning and end of the opinion, as well as the local contexts before and after each target passage. Each token in the contexts was individually embedded using the legal CBOW embedding and the embeddings were averaged over each context window. As before, the target citations were represented as a 5,000-dimensional vector.

The input vectors were fed into a first fully connected hidden layer with a rectified linear (ReLU) activation function and the resulting 512-dimensional vector was fed to a second fully connected hidden layer with a ReLU activation function to generate a 128-dimensional vector which was finally fed to a fully connected output layer with a softmax activation function to generate a 5,000-dimensional output vector. All three layers used I-2 regularization with a regularization constant of 10⁻³. Batch normalization was applied between the first two hidden layers. The FFNN model was trained using mini-batches of size 32 for a total of 10 epochs using the ADAM optimizer and categorical cross entropy loss. No further hyper parameter tuning was performed. As before, 5% of the training data was retained for testing.

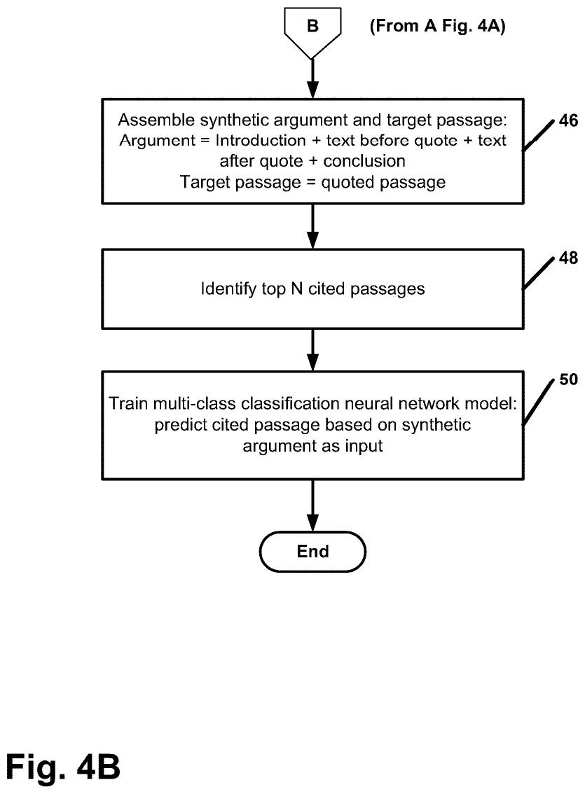

FIGS. 4A and 4B comprise a flow diagram showing illustrative processing that can be implemented within an LLP system, more particularly, within argument identification processors and/or prediction processors such as those described above in conjunction with FIG. 1.

Rectangular elements (typified by element 34), are herein denoted “processing blocks,” and represent computer software instructions or groups of instructions. Alternatively, the processing blocks may represent steps or processes performed by functionally equivalent circuits such as a machine learning processor, a digital signal processor circuit or an application specific integrated circuit (ASIC). The flow diagrams do not depict the syntax of any particular programming language, but rather illustrates the functional information one of ordinary skill in the art requires to fabricate circuits or to generate computer software to perform the processing described. It should be noted that many routine program elements, such as initialization of loops and variables and the use of temporary variables are not shown. It will be appreciated by those of ordinary skill in the art that unless otherwise indicated herein, the particular sequence of blocks described is illustrative only and can be varied without departing from the spirit of the concepts, structures, and techniques sought to be protected herein. Thus, unless otherwise stated the blocks described below are unordered, meaning that, when possible, the functions represented by the blocks can be performed in any convenient or desirable order.

The embodiments described herein can be implemented in various forms of hardware, software, firmware, or special purpose processors. For example, in one embodiment, a non-transitory computer readable medium includes instructions encoded thereon that, when executed by one or more processors, cause aspects of watermark system 504 described herein to be implemented. The instructions can be encoded using any suitable programming language, such as C, C++, object-oriented C, Java, JavaScript, Visual Basic, .NET, BASIC, Scala, or alternatively, using custom or proprietary instruction sets. Such instructions can be provided in the form of one or more computer software applications or applets that are tangibly embodied on a memory device, and that can be executed by a computer having any suitable architecture. In one embodiment, the system can be hosted on a given website and implemented, for example, using JavaScript or another suitable browser-based technology to render, for example, the masked watermarks and/or complement watermarks described herein.

The functionalities disclosed herein can optionally be incorporated into a variety of different software applications and systems. The functionalities disclosed herein can additionally or alternatively leverage services provided by separate software applications and systems. For example, in embodiments, the functionalities disclosed herein can be implemented in any suitable cloud environment. The computer software applications disclosed herein may include a number of different modules, sub-modules, or other components of distinct functionality, and can provide information to, or receive information from, still other components and services. These modules can be used, for example, to communicate with input/output devices such as a display screen, a touch sensitive surface, auditory interface, or any other suitable input/output device. Other components and functionality not reflected in the illustrations will be apparent in light of the description provided herein, and it will be appreciated that the present disclosure is not intended to be limited to any particular hardware or software configuration. Thus, in other embodiments, the system illustrated in FIG. 1 may include additional, fewer, or alternative subcomponents. Furthermore, in some cases, one or more of the elements, modules and/or components illustrated in FIG. 1 may be downloaded from a server computing system onto a user device for local execution.

In alternative embodiments, the processors and modules disclosed herein can be implemented with hardware, including gate level logic such as a field-programmable gate array (FPGA), or alternatively, a purpose-built semiconductor such as an application-specific integrated circuit (ASIC) or machine learning processors. After reading the description provided herein, it will be apparent to one of ordinary skill in the art that any suitable combination of hardware, database system, software, and firmware can be used in this regard, and that the present disclosure is not intended to be limited to any particular system architecture.

As will be further appreciated in light of the disclosure provided herein, for this and other processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

Turning now to FIGS. 4A, 4B, a process for identifying legal precedent relevant to a legal issue begins by retrieving one or more judicial opinions from one or more databases as shown in processing block 34. Processing then proceeds to processing block 36 wherein, in one or more judicial opinions which are retrieved, citations to other opinions are identified. Processing then proceeds to processing block 38 in which quotes are identified in the opinions identified in processing blocks 36, 38.

Processing then proceeds to processing block 40 in which it is determined whether a quotation in a first opinion (referred to as opinion A) is followed by a citation to another opinion (referred to as cited opinion B). Processing then proceeds to processing block 40 in which it is determined whether a quoted passage appears in cited opinion (B). If the quoted passage appears in cited opinion (B), then text before and after the quoted passage in opinion A is extracted. In addition to extracting text before and after quotation in opinion A, also extracted is text from an introduction and a conclusion of opinion A.

Processing then proceeds to processing block 46 in which a synthetic argument (or a “mini-opinion”) is generated. In embodiments, such mini-opinions may be generated for each quoted passage.

Referring briefly to FIG. 5A, as illustrated, in embodiments, a synthetic argument may be assembled using an introduction 54 from opinion A, text before the quoted passage 56 from opinion A, text after the quoted passage 58 from opinion A and a conclusion 60 from opinion A. As illustrated in FIG. 3A, at least some precedent is missing 62 from the mini-opinion.

Turning again to FIG. 4B, the target passage may then match the quoted passage. This is done to create training data for a model. Each piece of training data comprises an input (the synthetic argument from a given opinion) and a target passage (the passage that accompanied the argument in the opinion). The model will be trained to predict the target passage based on the argument.

Processing then proceeds to processing block 48 in which the top N cited passages are identified (where N is an integer greater than 1). As discussed above, a number of passages (and ideally, a small number of passages—e.g., less 30% of passages for a specific legal issue) account for the vast majority of citations. In one example embodiment, 5,000 passages are selected which accounts for around 20% of all citations for a particular legal issue. In practice one may select a larger value for N to also include more unusual passages, but this comes with longer training times. However, since it has been discovered herein that most passages are cited very rarely, one will almost certainly never have to select an N close to as large as the number of possible passages (about 1.5 million in one example embodiment).

Processing then proceeds to processing block 50 in which multi-class classification neural network models are trained to predict missing cited passages 64 (FIG. 5B) using the synthetic argument (FIG. 5A) as an input.

Next described are results achieved by an example LPP system.

### Macro-Averaged Evaluation Metrics

The accuracy of multi-class classification models can be misleading, especially when classes are imbalanced as in this case. Thus, evaluation metrics for multi-class text classifications (such as those described in Damaschk et al. 2019) may be adapted to evaluate the models' performances.

A correct label yₓ is associated with each sample x in the test set X. The model predicts a label ŷₓ which can be used to calculate the class-wise precision (P), recall (R) and F-Score (F):

$$P ( y ) = \frac{\vert \{ x ∈ X \vert {y}_{x} = y ∧ {y}_{x} = {\hat{y}}_{x} \} \vert}{\vert \{ x ∈ X \vert {\hat{y}}_{x} = y \} \vert} \qquad ( 1 )$$

$$R ( y ) = \frac{\vert \{ x ∈ X \vert {y}_{x} = y ∧ {y}_{x} = {\hat{y}}_{x} \} \vert}{\vert \{ x ∈ X \vert {y}_{x} = y \} \vert} \qquad ( 2 )$$

$$F ( y ) = \frac{2 \cdot P ( y ) \cdot R ( y )}{P ( y ) + R ( y )} \qquad ( 3 )$$

For each metric above, two evaluation metrics over the entire unseen test set can be calculated. First, using the frequencies of the labels as weights, a weighted mean on the metrics can be calculated to obtain a metric that reflects class imbalance.

Second, the three metrics can be macro-averaged, which represents an unweighted mean of each metric, to obtain a measure that is not biased by a strong performance in the most frequent classes.

Evaluating the models on the unseen test set (Table 2) shows that the fine-tuned BERT model outperforms the FFNN but that the BERT model is biased towards predicting more frequently cited passages.

TABLE 2

| Model | | P | R | F |
|---|---|---|---|---|
| BERT | Macro | 0.58 | 0.60 | 0.56 |
| | Weighted | 0.72 | 0.73 | 0.71 |
| FFNN | Macro | 0.37 | 0.38 | 0.34 |
| | Weighted | 0.39 | 0.35 | 0.33 |

As can be observed from Table 2, the fine-tuned BERT model outperforms the FFNN across all metrics but is biased towards the overrepresented passages while the FFNN has a comparable performance on both frequent and infrequent passages.

### Top-k Accuracy

In practice, lawyers would likely use LPP models to make numerous recommendations and use their legal training to decide which of these recommendations should be used in their legal argument. Therefore, it is sensible to evaluate how often the target passage is among the Top-k predictions produced by the model.

TABLE 3

| Model | Top-10 | Top-20 | Top-50 | Top-100 |
|---|---|---|---|---|
| BERT | 0.96 | 0.98 | 0.99 | 0.99 |
| FFNN | 0.81 | 0.90 | 0.95 | 0.98 |

As can be observed in Table 3, although both models reliably predict the correct passage, the BERT model outperforms the FFNN's Top-k accuracy for all values of k between 10 and 100.

Comparing the Top-k accuracy for both models on the unseen test set (Table 3) shows that both are able to place the correct citation among the top predictions, although the BERT model clearly outperforms the FFNN.

### Evaluation Summary

The Top-k accuracy an important metric since it is especially useful for lawyers in practice. The reasonably high Top-k accuracy indicates that both models have successfully learned the semantic connection between legal arguments and relevant citation passages.

The BERT model, unlike the FFNN, is biased towards predicting the more frequently cited passages, however, it outperforms the FFNN across all other metrics. It must be underscored that the BERT model is much more resource intensive to train. Both models were trained on the same GPU and while the FFNN (1,327,624 parameters) was trained in 13 minutes, the BERT model (113,327,240 parameters) required 20 hours of training time.

Given the skill and training associated with legal practice, these results are highly encouraging and suggest that NLP techniques have the ability to predict precedent relevant to legal arguments, at least when these arguments rest on commonly cited precedent. The results suggest a perhaps unsurprisingly close semantic connection between the context of a legal argument (both local and global) and the relevant citations. The models demonstrate that identifying the correct legal precedent on the basis of semantic context alone is possible, and no extraneous legal knowledge is required in many instances.

### LPP Testing

To test the LPP system, “unseen” testing data was used. The unseen testing data, like the training data, came from judicial opinions, in practice however, LPP models are likely to be used by lawyers to draft briefs more efficiently and effectively. In contrast to judicial opinions, legal briefs cannot be readily obtained en masse in a machine readable format. Therefore, two complex high quality legal briefs were chosen at random to provide an insight into model performance in a realistic setting. Due to its superior performance, only the BERT model was evaluated on the briefs.

The first brief (Kagan et al., 2010) was submitted to the U.S. Supreme Court. It was co-authored by Elena Kagan, a former U.S. Solicitor General and current U.S. Supreme Court Justice. The brief is 86 pages long and, among other things, argues that the Petitioner's right to a fair trial was not violated due to the pretrial publicity his case had received. Five sentences that seemed to provide a good overview of the argument were manually extracted from the brief and used as an input to the BERT model with no further preprocessing. The top-10 predictions from the model were subsequently analyzed to determine whether (a) they had appeared in the brief, and (b) they were relevant to the argument made in the brief. Of the ten predicted passages, seven were deemed relevant to the brief. Table 4 shows these seven relevant passages, of which three appeared in the brief, two belonged to an opinion from which another passage was cited in the brief, and two seemed relevant but were not cited. It should be noted that in Table 4, the text is taken directly from a database which contains some errors due to the process by which the legal opinions stored therein are scanned and digitizes.

TABLE 4
Model Input: The district court did not err in denying petitioner's motions for
a change of venue. Petitioner's central contention is that the degree and nature
of pretrial publicity, and the impact of Enron's collapse on Houston, gave rise
to an irrebuttable presumption of prejudice among the entire venire. But this
Court's cases - and the Constitution - are satisfied if the jurors who actually
sat are impartial. Because the jury that decided his case was impartial, petitioner
has failed to establish a constitutional violation. The Constitution requires
trial before an impartial jury. The district court's denial of petitioner's
motion for a change of venue did not violate his constitutional rights.

| Proposed Passage | Relevance |
|---|---|
| This Court has long held that the remedy for | Relevant; |
| allegations of juror partiality is a hearing in which the | Cited |
| defendant has the opportunity to prove actual bias. | |
| Smith v. Phillips, 455 U.S. 209, 215 (1982) | |
| In essence, the right to jury trial guarantees to the | Relevant; |
| criminally accused a fair trial by a panel of impartial, | Another |
| “indifferent” jurors. Irvin v. Dowd, | passage |
| 366 U.S. 717, 722 (1961) | cited |
| Due process means a jury capable and willing to | Relevant; |
| decide the case solely on the evidence before it. | Cited |
| Smith v. Phillips, 455 U.S. 209 (1982) | |
| The voir dire in this case indicates no such hostility to | Relevant; |
| petitioner by the jurors who served in his trial as to suggest a | Another |
| partiality that could not be laid aside. Murphy v. Florida, 421 | passage |
| U.S. 794, 800 (1975). | cited |
| It is sufficient if the juror can lay aside his impression | Relevant; |
| or opinion and render a verdict based on the evidence | Cited |
| presented in court. Irvin v. Dowd, 366 U.S. 717, 723 (1961) | |
| The test under Kotteakos is whether the error “had | Relevant; |
| substantial and injurious effect or influence in determining the | Not Cited |
| jury's verdict.” Brecht v. Abrahamson, 507 U.S. 619, 637 | |
| (1993) | |
| In a criminal case, any private communication, contact, | Relevant; |
| or tampering, directly or indirectly, with a juror during a trial | Not Cited |
| about the matter pending before the jury is, for obvious | |
| reasons, deemed presumptively prejudicial, if not made in | |
| pursuance of known rules of the court and the instructions and | |
| directions of the court made during the trial, with full knowledge | |
| of the parties. Remmer v. United States, 347 U.S. 227, 229 | |
| (1954) | |

As can be observed form Table 4, seven of the ten predicted citations are relevant to the argument in the brief.

The second brief (Bridges et al., 2006) was featured in Garner (2014) as one of the “best ever” legal briefs. The 62-page brief argued that an alien stopped at a U.S. border has a constitutional right to be free from false imprisonment and from the use of excessive force by U.S. law enforcement personnel. As before, the BERT model was given an input consisting of a few sentences from the brief and generated ten predictions. Table 5 shows the seven predictions that were deemed relevant to the brief.

TABLE 5
Model Input: More than 100 years ago, the Supreme Court ruled that the protection
of our Constitution reaches all people within the territory of the United States
regardless of their citizenship. The Fourteenth Amendment's pledges of due
process and equal protection apply. Congress's “Plenary Power” over
immigration is the source of the entry fiction. The entry-fiction doctrine derives
from the recognition that the political branches of government are more appropriately
suited to function as gatekeeper of the nation's borders. Even if plenary,
Congress's immigration power has never been unlimited. The Court should affirm
the district court's denial of summary judgment because the Fourth and Fifth
Amendments did protect Martinez-Aguero from gross physical abuse and inhumane
treatment once she entered the territory of the United States.

| Proposed Passage | Relevance |
|---|---|
| It is well established that the Fifth Amendment entitles | Relevant; |
| aliens to due process of law in deportation proceedings. | Not Cited |
| Reno v. Flores, 507 U.S. 292, 306 (1993).” | |
| Courts have long recognized the power to expel or | Relevant; |
| exclude aliens as a fundamental sovereign attribute | Cited |
| exercised by the Government's political departments largely | |
| immune from judicial control. Shaughnessy v. United States | |
| ex rel. Mezei, 345 U.S. 206, 210 (1953). | |
| The Court held that “when the Executive exercises this | Relevant; |
| [delegated] power negatively on the basis of a facially | Another |
| legitimate and bona fide reason, the courts will neither look | passage |
| behind the exercise of that discretion, nor test it by balancing | cited |
| its justification against the First Amendment interests of those | |
| who seek personal communication with the applicant. | |
| Fiallo v. Bell, 430 U.S. 787, 794 (1977). | |
| This Court has repeatedly emphasized that “over no | Relevant; |
| conceivable subject is the legislative power of Congress | Another |
| more complete than it is over” the admission of aliens. | passage |
| Fiallo v. Bell, 430 U.S. 787, 792 (1977). | cited |
| We hold that when the Executive exercises this power | Relevant; |
| negatively on the basis of a facially legitimate and bona fide | Another |
| reason, the courts will neither look behind the exercise of that | passage |
| discretion, nor test it by balancing its justification against the | cited |
| First Amendment interests of those who seek personal | |
| communication with the applicant. Kleindienst v. Mandel, 408 | |
| U.S. 753, 770 (1972). | |
| Our cases “have long recognized the power to expel or | Relevant; |
| exclude aliens as a fundamental sovereign attribute exercised | Another |
| by the Government's political departments largely immune | passage |
| from judicial control. Fiallo v. Bell, 430 U.S. 787, 792 (1977). | cited |
| For a host of constitutional and statutory provisions rest | Relevant; |
| on the premise that a legitimate distinction between citizens | Another |
| and aliens may justify attributes and benefits for one class not | passage |
| accorded to the other; and the class of aliens is itself a | cited |
| heterogeneous multitude of persons with a wide-ranging | |
| variety of ties to this country. Mathews v. Diaz, | |
| 426 U.S. 67, 79 (1976). | |

As can be observed from Table 5, seven of the ten predicted citations are relevant to the brief. Although several predicted passages stem from the same opinion, these passages themselves contain relevant references to other opinions, several of which appear in the legal brief.

One was cited in the brief, five belonged to an opinion from which another passage was cited, and one seemed relevant but was not cited. The model provided three passages from the same opinion and each of these passages cited a passage in another opinion which was relevant to the brief.

Overall, the performance on these legal briefs provides an indication that the BERT LPP model would perform well in practice. Several highly skilled attorneys spent hundreds of hours working on these briefs and the fact that a model can predict relevant passages of precedent based on a few sentences of context is highly encouraging.

Although reference is made herein to particular databases and precedential opinions, it is appreciated that other legal resources may also be used and a person having ordinary skill in the art would understand how to select such legal resources and incorporate them into embodiments of the concepts, systems and techniques set forth herein without deviating from the scope of those teachings.

Various embodiments of the concepts, systems, devices, structures and techniques sought to be protected are described herein with reference to the related drawings. It is appreciated that alternative embodiments can be devised without departing from the scope of the concepts, systems, devices, structures and techniques described herein.

Additionally, the term “exemplary” is used herein to mean “serving as an example, instance, or illustration. Any embodiment or design described herein as “exemplary” is not necessarily to be construed as preferred or advantageous over other embodiments or designs. The terms “one or more” and “one or more” are understood to include any integer number greater than or equal to one, i.e., one, two, three, four, etc. The terms “a plurality” are understood to include any integer number greater than or equal to two, i.e. two, three, four, five, etc. The terms “coupled,” “connection” or variants thereof can include an indirect connection or coupling and a direct connection or coupling.

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

It is to be understood that the disclosed subject matter is not limited in its application to the details of construction and to the arrangements of the components set forth in the above description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Accordingly, although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A system comprising:
(a) means for identifying one or more passages of judicial precedent to be used in a legal document using natural language processing, the natural language processing including one or more transformer-based language models trained on a legal corpus and configured to predict passages of precedent relevant to a legal argument, wherein judicial precedent refers to one or more passages relevant to one or more holdings and the context of a case from which the precedent is taken;
(b) means for identifying one or more arguments which use the identified one or more passages of judicial precedent;
(c) means for assembling the one or more the identified passages of judicial precedent into one or more synthetic arguments for use in a legal document, and
(d) means for utilizing one or more synthetic legal arguments to predict missing precedent.

2. The system of claim 1 wherein the means for identifying passages of judicial precedent comprises means for accessing one or more databases of judicial decisions.

3. The system of claim 1 wherein the means for assembling comprises means for selecting text before and/or after more the identified passages of judicial precedent.

4. (canceled)

5. (canceled)

6. (canceled)

7. (canceled)

8. A system comprising:
(a) means for identifying one or more judicial court decisions relevant to an identified legal issue;
(b) means for identifying, from at least one of the one or more identified judicial decisions, one or more passages of judicial precedent to be used in a legal document, wherein judicial precedent refers to one or more passages relevant to one or more holdings and one or more contexts of a judicial decision from which the precedent is taken;
(c) means for processing the one or more passages of precedent using natural language processing;
(d) means for assembling one or more synthetic arguments using the one or more identified passages of precedent in the legal document,
wherein the natural language processing includes at least one of:
a transformer-based language model trained on a legal corpus and configured to predict passages of precedent relevant to a legal argument;
a multi-layer perceptron (a/k/a feed forward neural network) trained on a legal corpus and configured to predict passages of precedent relevant to a legal argument; and
custom legal word embedding configured to predict passages of precedent relevant to a legal argument, wherein each synthetic argument corresponds to an identified passage of precedent and wherein each synthetic argument consists of the following in an order as listed:
an introduction;
text which occurs before respective identified passage of precedent;
text which occurs after the respective identified passage of precedent; and
a conclusion; and
(e) means for utilizing one or more synthetic legal arguments to predict missing precedent.

9. The system of claim 8 wherein the means for identifying passages of judicial precedent comprises means for accessing one or more databases of judicial decisions.

10. (canceled)

11. (canceled)

12. (canceled)

13. A computer-implemented method for natural language processing of judicial decisions stored in one or more databases to identify one or more instances of legal precedence relevant to an identified legal argument, the computer-implemented method comprising:
training a model configured to predict passages of precedent relevant to a legal argument on the identified legal argument, wherein precedent refers to one or more passages relevant to one or more holdings and one or more contexts of a judicial decision from which the precedent is taken, wherein training a model includes:
automatically selecting at least one of:
portions of text before the identified one or more passages relevant to the identified legal argument;
portions of text after the identified one or more pas ages relevant to the identified legal argument;
automatically extracting the selected portions of text from the corresponding judicial decision;
receiving the identified legal argument in a processor via a user interface;
automatically accessing at least one of the one or more databases having judicial decisions stored therein;
automatically identifying one or more judicial decisions relevant to the identified legal argument;
in each identified one or more judicial decisions, automatically identifying one or more passages relevant to the identified legal argument; and
via the model, returning passages of precedent about the identified legal argument; and
automatically assembling a synthetic legal argument using the extracted selected portions of text, wherein the synthetic leg argument automatically assembled using the extracted selected portions of text consists of the following in an order as listed:
an introduction;
text which occurs before the identified one or more passages;
text which occurs after the identified one or more passages, and
a conclusion; and
utilizing the one or more synthetic les al arguments to predict missing precedent.

14. (canceled)

15. (canceled)

16. The computer-implemented method of claim 13, wherein automatically accessing at least one of the one or more databases having judicial decisions stored therein comprises automatically accessing at least one of the one or more databases having judicial decisions stored therein via a database resource processor.

17. (canceled)

18. (canceled)

19. (canceled)

20. The system of claim 2, wherein the means for accessing one or more databases of judicial decisions include a database resource processor configured to select at least one portion of the one or more databases relevant to an identified legal issue.

21. The system of claim 9, wherein the means for accessing one or more databases of judicial decisions include a database resource processor configured to select at least one portion of the one or more databases relevant to the identified legal issue.

22. The computer-implemented method of claim 13, wherein accessing at least one of the one or more databases includes selecting, by a database resource processor, one or more portions of the one or more databases relevant to the identified legal argument.

23. The system of claim 1, wherein the each of the one or more synthetic arguments corresponds to an identified passage of precedent and wherein each of the one or more synthetic arguments consists of the following in an order as listed:
an introduction;
text which occurs before the respective identified passage of precedent;
text which occurs after the respective identified passage of precedent; and
a conclusion.

24. The system of claim 23, wherein the missing precedent is inserted between the text which occurs before the respective identified passage of precedent and the text which occurs after the respective identified passage of precedent.

25. The system of claim 8, wherein the missing precedent is inserted between the text which occurs before the respective identified passage of precedent and the text which occurs after the respective identified passage of precedent.

26. The computer-implemented method of claim 13, wherein the missing precedent is inserted between the text which occurs before the respective identified passage of precedent and the text which occurs after the respective identified passage of precedent.

27. The system of claim 2, wherein the databases of judicial decisions comprises one or more of judicial arguments in opinions from the U.S. Supreme Court; judicial arguments in opinions from the U.S. Federal court system; and judicial arguments in opinions from U.S. State Courts.

28. The system of claim 9, wherein the databases of judicial decisions comprises one or more of judicial arguments in opinions from the U.S. Supreme Court; judicial arguments in opinions from the U.S. Federal court system; and judicial arguments in opinions from U.S. State Courts.

29. The computer-implemented method of claim 16, wherein the one or more databases having judicial decisions stored therein comprises one or more databases comprising judicial arguments in opinions from the U.S. Supreme Court; judicial arguments in opinions from the U.S. Federal court system; and judicial arguments in opinions from U.S. State Courts.
